(19) United States
(12) Patent Application Publication
(10) Pub. No.: US 2020/0377314 A1
(43) Pub. Date: Dec. 3, 2020

(54) End Effector and Picking System

(71) Applicant: Hitachi, Ltd., Tokyo (JP)

(72) Inventor: Hiroshi IKEDA, Tokyo (JP)

(21) Appl. No.: 16/825,480

(22) Filed: Mar. 20, 2020

(30) Foreign Application Priority Data
May 29, 2019 (JP) 2019-100041

(51) Int. Cl. B65G 47/91; B25J 15/06; B25J 15/00; B25J 19/02; B65G 47/71

(52) U.S. Cl. CPC B65G 47/91; B25J 15/0683; B25J 15/00; B65G 2201/02; B25J 19/023; B65G 47/71; B65G 47/914

(57) ABSTRACT

An end effector includes suction pads and, a near support portion, and a far support portion. The suction pads have a suction surface that comes into contact with an article. The near support portion is arranged around an outer edge of the suction surface, comes into contact with the article, and supports the article. The far support portion is arranged at a position farther from the outer edge of the suction surface than the near support portion, comes into contact with the article, and supports the article.

### BACKGROUND OF THE INVENTION

### 1. Field of the Invention

The present invention relates to an end effector that sucks, holds, and releases an article, and a picking system including the end effector.

### 2. Description of the Related Art

There is known a picking system that holds an article loaded from an upstream process using a transfer robot, unloads the article to an unloading unit, and unloads the article to a downstream process via the unloading unit. When the transfer robot holds the article, an end effector that sucks, holds, and releases the article is used.

An example of the conventional end effector is described in JP 2019-10719 A. JP 2019-10719 A describes a technique in which at least one suction pad configured to suck work and a leveling plate configured to level the work are attached to a base.

### SUMMARY OF THE INVENTION

In the picking system, however, there is a case where an article of which to-be-sucked surface is inclined with respect to the horizontal direction, or a case where an article is conveyed in the state of being inclined with respect to the horizontal direction. In the technique described in JP 2019-10719 A, however, when the article is inclined with respect to the horizontal direction, there is a possibility that the article may drop.

In consideration of the above problem, an object of the invention is to provide an end effector and a picking system that can reliably suck and hold an article even in a state where the article is inclined with respect to a horizontal direction.

In order to solve the above problem and achieve the object, an end effector includes a suction pad, a near support portion, and a far support portion. The suction pad has a suction surface that comes into contact with an article. The near support portion is arranged around an outer edge of the suction surface, comes into contact with the article, and supports the article. The far support portion is arranged at a position farther from the outer edge of the suction surface than the near support portion, comes into contact with the article, and supports the article.

Further, a picking system includes: an end effector that sucks, holds, and releases an article; a transfer robot having the end effector provided on an arm; a loading conveyor that loads the article to the transfer robot; and an unloading unit to which the article is unloaded from the transfer robot. As the end effector, the above-described end effector is used.

According to the end effector and the picking system configured as described above, it is possible to reliably suck and hold an article even in a state where the article is inclined with respect to the horizontal direction.

### BRIEF DESCRIPTION OF THE DRAWINGS

FIG. 1 is a perspective view illustrating an end effector according to a first embodiment;

FIG. 2 is a plan view of the end effector according to the first embodiment as viewed from a bottom surface side;

FIG. 3 illustrates the end effector according to the first embodiment, which is a cross-sectional view of taken along line A-A illustrated in FIG. 2;

FIG. 4 is a cross-sectional view illustrating a state where a suction pad in the end effector according to the first embodiment is maximally contracted;

FIG. 5 is a cross-sectional view illustrating a state where the end effector according to the first embodiment sucks an article;

FIG. 6 is an explanatory view illustrating a state where the end effector according to the first embodiment sucks the article, and illustrates a state where a to-be-sucked surface of the article is inclined with respect to the horizontal direction;

FIG. 7 is a perspective view illustrating an end effector according to a second embodiment;

FIG. 8 is a plan view of the end effector according to the second embodiment as viewed from a bottom surface side;

FIG. 9 is a plan view of an end effector according to a third embodiment as viewed from a bottom surface side;

FIG. 10 is a plan view of an end effector according to a fourth embodiment viewed from a bottom surface side;

FIG. 11 is a perspective view illustrating an example of an article conveyed by a picking system according to an embodiment;

FIG. 12 is a perspective view illustrating a state where a plurality of articles are stored in a storage cardboard;

FIG. 13 is a schematic configuration view illustrating the picking system according to the embodiment;

FIG. 14 is a schematic configuration view illustrating an operation example of the picking system according to the embodiment;

FIG. 15 is a schematic configuration view illustrating the operation example of the picking system according to the embodiment;

FIG. 16 is a schematic configuration view illustrating the operation example of the picking system according to the embodiment;

FIG. 17 is a schematic configuration view illustrating the operation example of the picking system according to the embodiment;

FIG. 18 is a schematic configuration view illustrating the operation example of the picking system according to the embodiment;

FIG. 19 is a schematic configuration view illustrating the operation example of the picking system according to the embodiment;

FIG. 20 is a schematic configuration view illustrating the operation example of the picking system according to the embodiment;

FIG. 21 is a schematic configuration view illustrating the operation example of the picking system according to the embodiment;

FIG. 22 is a schematic configuration view illustrating the operation example of the picking system according to the embodiment;

FIG. 23 is a schematic configuration view illustrating the operation example of the picking system according to the embodiment;

FIG. 24 is a schematic configuration view illustrating the operation example of the picking system according to the embodiment;

FIG. 25 is a schematic configuration view illustrating the operation example of the picking system according to the embodiment;

FIG. 26 is a schematic configuration view illustrating the operation example of the picking system according to the embodiment;

FIG. 27 is a schematic configuration view illustrating the operation example of the picking system according to the embodiment; and

FIG. 28 is a schematic configuration view illustrating the operation example of the picking system according to the embodiment.

### DESCRIPTION OF THE PREFERRED EMBODIMENTS

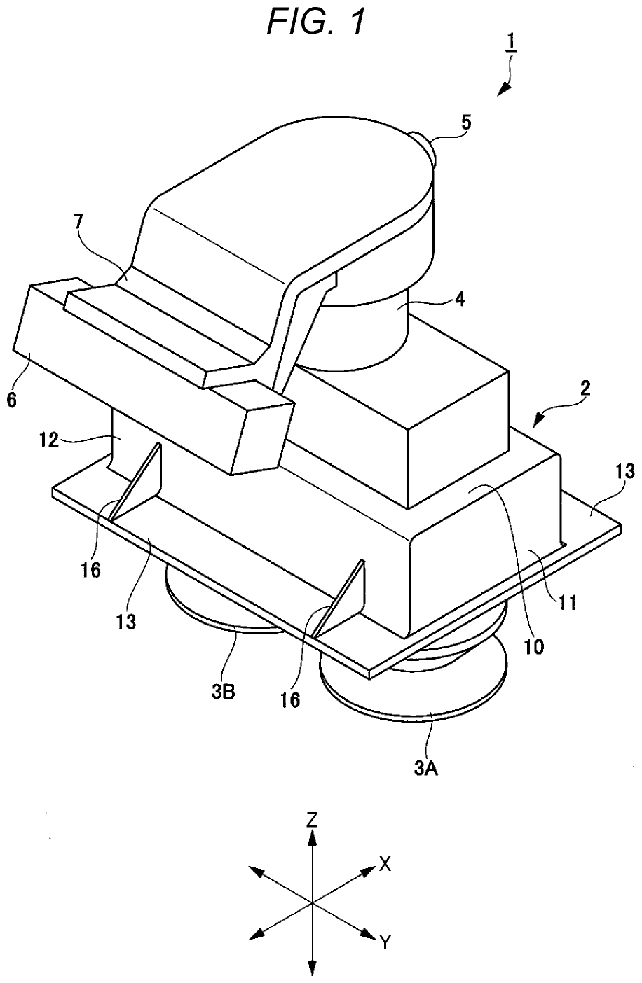

Hereinafter, embodiments of an end effector and a picking system will be described with reference to FIGS. 1 to 28. Incidentally, common members in the drawings will be denoted by the same reference signs.

### 1. First Embodiment of End Effector

### 1-1. Configuration Example of End Effector

First, a configuration of an end effector according to a first embodiment (hereinafter referred to as “the present example”) will be described with reference to FIGS. 1 to 4.

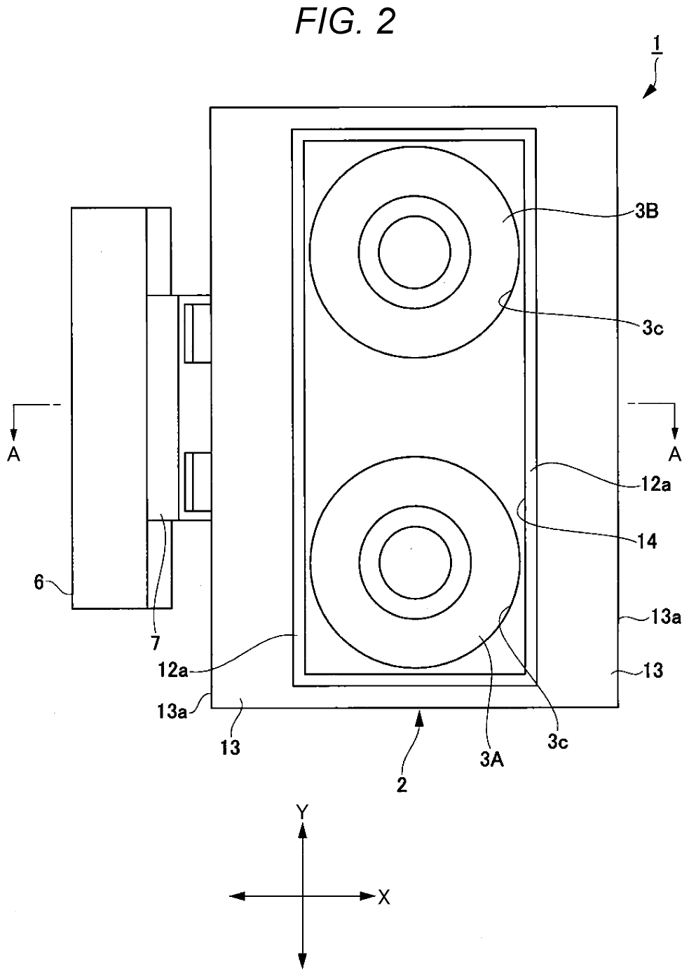

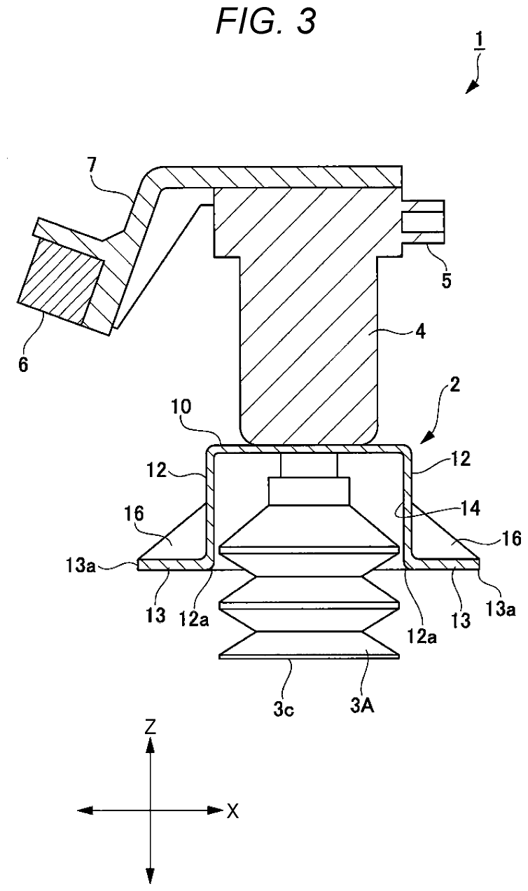

FIG. 1 is a perspective view illustrating the end effector of the present example, FIG. 2 is a plan view of the end effector viewed from a bottom surface side, and FIG. 3 is a cross-sectional view taken along line A-A illustrated in FIG. 2.

The device illustrated in FIG. 1 is, for example, an end effector 1 that is attached to a robot arm having a joint with two or more axes, sucks, and holds an article. Further, the end effector 1 is configured to be capable of releasing the article held by suction. As illustrated in FIGS. 1 to 3, the end effector 1 includes a cover member 2, two suction pads 3A and 3B, an arm portion 4, a pipe joint 5, a camera 6, and a camera arm 7.

The cover member 2 is formed in a hollow container shape with one open surface. Specifically, the cover member 2 is formed in a substantially rectangular parallelepiped shape. The cover member 2 has an upper surface 10, a pair of first side surfaces 11 and 11, a pair of second side surfaces 12 and 12, and two support members 13 and 13. The upper surface 10 is formed in a substantially rectangular shape. The arm portion 4 is connected to the upper surface 10. The cover member 2 is supported by the arm portion 4.

The pair of first side surfaces 11 and 11 are substantially vertically continuous from both ends of the upper surface 10 in the longitudinal direction. Further, the pair of second side surfaces 12 and 12 are substantially vertically continuous from both ends of the upper surface 10 in the lateral direction.

Hereinafter, the lateral direction of the upper surface 10 is referred to as a first direction X, and the longitudinal direction of the upper surface 10 is referred to as a second direction Y. A direction orthogonal to the first direction X and the second direction Y, that is, an up-down direction of the end effector 1 is referred to as a third direction Z.

The pair of first side surfaces 11 and 11 oppose each other in the second direction Y, and the pair of second side surfaces 12 and 12 oppose each other in the first direction X. The second side surface 12 is substantially vertically continuous from both ends of the first side surface 11 in the first direction X.

Further, one end of the second side surface 12 in the third direction Z, that is, a near support portion 12a, which is a lower end in the up-down direction, is arranged around suction surfaces 3c of the suction pads 3A and 3B to be described later. The support member 13 is substantially vertically continuous from the near support portion 12a. The support member 13 is formed in a substantially flat plate shape. The support member 13 protrudes from the near support portion 12a in the first direction X. An end of the support member 13 opposite to the near support portion 12a serves as a far support portion 13a. Then, the far support portion 13a is arranged at a position farther from the suction surface 3c than the near support portion 12a.

The near support portion 12a and the far support portion 13a are located on a plane formed by the first direction X and the second direction Y. That is, the near support portion 12a and the far support portion 13a are arranged at the same position in the third direction Z.

Further, a reinforcing rib 16 is provided between the second side surface 12 and the support member 13.

The two suction pads 3A and 3B are arranged in a space 14 surrounded by the upper surface 10, the pair of first side surfaces 11 and 11, and the pair of second side surfaces 12 and 12. The two suction pads 3A and 3B are covered by the cover member 2 in the first direction X and the second direction Y and the other side in the third direction Z. The other ends of the two suction pads 3A and 3B in the third direction Z are connected to the arm portion 4. The two suction pads 3A and 3B communicate with a suction path (not illustrated) provided on the arm portion 4.

Further, the first suction pad 3A is arranged on one side of the second direction Y in the space 14 of the cover member 2, and the second suction pad 3B is arranged on the other side in the second direction Y in the space 14 of the cover member 2.

Each of the two suction pads 3A and 3B is formed in a bellows shape using a flexible member. The suction pads 3A and 3B is extended and contracted along the third direction Z. One end of the suction pads 3A and 3B in the third direction Z, that is, the suction surface 3c is formed in a substantially circular shape. Then, the suction surface 3c is exposed from the opening of the cover member 2.

As illustrated in FIG. 3, in the extended state where the article is not adsorbed, the suction surfaces 3c of the suction pads 3A and 3B protrude toward one side of the cover member 2 in the third direction Z more than the near support portion 12a and the far support portion 13a. That is, the suction surface 3c protrudes in a direction closer to the article than the near support portion 12a and the far support portion 13a.

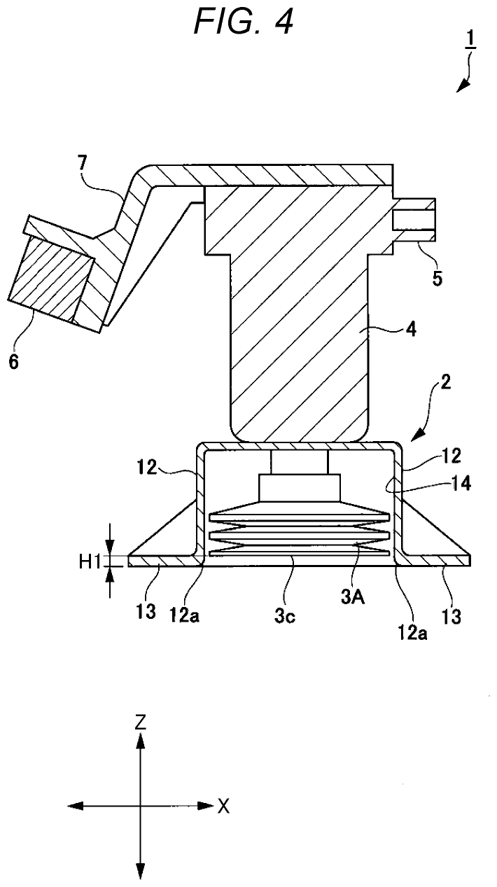

FIG. 4 is a cross-sectional view illustrating a state where the suction pads 3A and 3B are maximally contracted.

When the suction pads 3A and 3B are maximally contracted as illustrated in FIG. 4, the suction surfaces 3c of the suction pads 3A and 3B are arranged closer to the other side of the cover member 2 in the third direction Z than the near support portion 12a and the far support portion 13a, that is, at a position away from the article. At this time, an interval of a length H1 is formed in the third direction Z between the suction surfaces 3c of the suction pads 3A and 3B and the near support portion 12a. Outer edges of the suction surfaces 3c of the suction pads 3A and 3B are arranged close to the near support portion 12a.

Next, the arm portion 4 will be described. As illustrated in FIGS. 1 and 3, the pipe joint 5 is provided at the other end of the arm portion 4 in the third direction Z in order for connection with a suction pump (not illustrated).

The pipe joint 5 is connected to the suction path (not illustrated) formed in the arm portion 4.

The camera arm 7 is provided at the other end of the arm portion 4 in the third direction Z. The camera arm 7 protrudes from the other end of the arm portion 4 toward one side in the first direction X.

A distal end of the camera arm 7 protrudes toward the one side in the first direction X from the far support portion 13a of the support member 13.

The camera 6 is attached to the distal end of the camera arm 7. The camera 6 is supported by the camera arm 7 and captures images one side of the third direction Z, that is, the lower part of the end effector 1 in the up-down direction. Then, the camera 6 images the two suction pads 3A and 3B and the article to be sucked and held.

The direction in which the camera arm 7 protrudes from the arm portion 4 is not limited to the first direction X. For example, the camera arm 7 may protrude from the arm portion 4 in the second direction Y.

### 1-2. Operation Example of End Effector

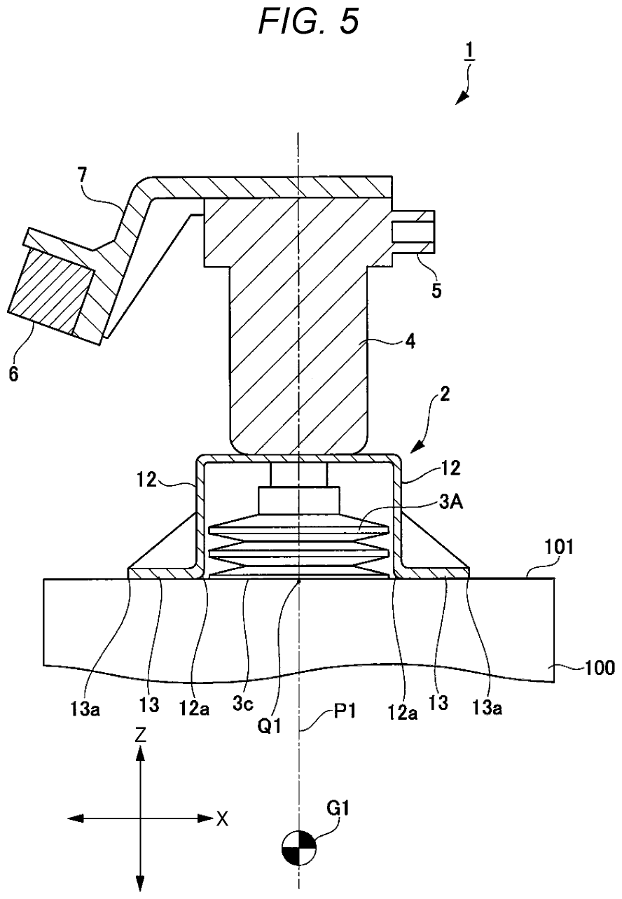

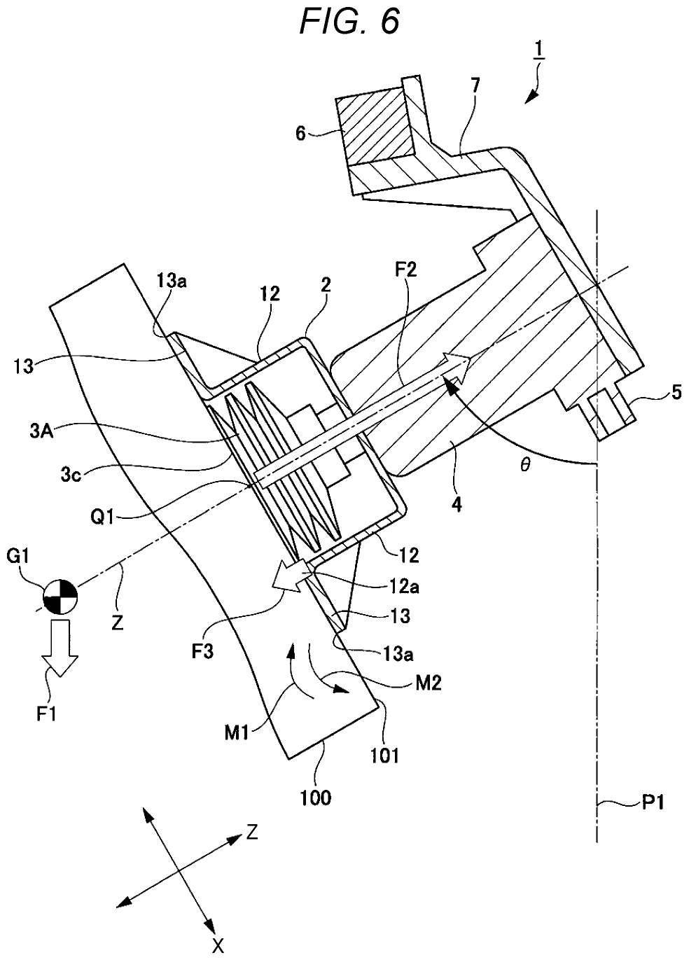

Next, an operation example of the end effector 1 having the above-described configuration will be described with reference to FIGS. 5 and 6.

FIG. 5 is a cross-sectional view illustrating a state where the end effector 1 sucks an article 100. In the example illustrated in FIG. 5, an example in which a to-be-sucked surface 101 of the article 100 is parallel to the horizontal direction will be described.

As illustrated in FIG. 5, when one end of the cover member 2 in the third direction Z is brought into contact with the to-be-sucked surface 101 of the article 100, the suction pads 3A and 3B are contracted. Center points Q1 of the suction surfaces 3c of the suction pads 3A and 3B are arranged above a center of gravity G1 of the article 100 in a vertical direction P1. At this time, the first direction X and the second direction Y of the end effector 1 are parallel to the horizontal direction, and the third direction Z is parallel to the vertical direction P1.

When the cover member 2 comes into contact with the to-be-sucked surface 101 of the article 100, positions of the suction surfaces 3c of the suction pads 3A and 3B in the third direction Z on the near support portion 12a and the far support portion 13a coincide. Therefore, the suction surfaces 3c of the suction pads 3A and 3B, the near support portion 12a, and the far support portion 13a come into contact with the to-be-sucked surface 101 of the article 100. Then, the article 100 is sucked by the suction pads 3A and 3B by driving the suction pump (not illustrated). The article 100 is supported by the near support portion 12a and the far support portion 13a.

As described above, when the suction pads 3A and 3B are maximally contracted, the suction surface 3c is located closer to the other side in the third direction Z than the near support portion 12a and the far support portion 13a. As a result, when the suction pads 3A and 3B suction the article 100, the to-be-sucked surface 101 of the article 100 is pressed against the near support portion 12a. As a result, the near support portion 12a can be reliably brought into contact with the to-be-sucked surface 101 of the article 100, and the article 100 can be supported by the near support portion 12a.

The near support portion 12a is arranged close to the outer edge of the suction surface 3c. Therefore, it is possible to prevent the to-be-sucked surface 101 from being deformed due to suction forces of the suction pads 3A and 3B by the near support portion 12a.

Next, a state where the to-be-sucked surface 101 of the article 100 is inclined with respect to the horizontal direction will be described with reference to FIG. 6.

FIG. 6 is an explanatory view illustrating the state where the article 100 is inclined. In the example illustrated in FIG. 6, a description will be given regarding an example will be described in which the third direction Z of the end effector 1 is inclined at an angle θ with respect to the vertical direction P1, and the first direction X is inclined with respect to the horizontal direction.

As illustrated in FIG. 6, a first force F1 generated by its own weight acting on the center of gravity G1 of the article 100, and a second force F2 which is a suction force by which the suction pads 3A and 3B suck the article 100 act on the article 100. Since the suction surface 3c is pressed against the near support portion 12a as described above, a third force F3 which is a reaction force from the near support portion 2a also acts on the article 100.

Further, a first rotational moment Ml and a second rotational moment M2 opposite to the first rotational moment Ml are generated around the far support portion 13a arranged in the lower part the vertical direction Pl. The first rotational moment M1 is directed in a direction in which the article 100 is pressed against the cover member 2 by the second force F2. On the other hand, the second rotational moment M2 is directed in a direction in which the article 100 is away from the cover member 2 by the first force F1 and the third force F3.

A position of the far support portion 13a and the second force F2 are set such that the first rotational moment M1 is larger than the second rotational moment M2. As a result, even when the angle θ changes from 0 to 90 degrees, the article 100 can be brought into contact with the near support portion 12a and the far support portion 13a of the cover member 2, and the article 100 can be reliably held.

In order to increase the first rotational moment M1, it is preferable that the position where the far support portion 13a is provided, that is, a length of the support member 13 in the first direction X be longer. However, the camera 6 is arranged on the other side of the support member 13 in the third direction Z. Therefore, the length of the support member 13 in the first direction X is set to such a length that does not disturb an imaging area of the camera 6. Therefore, the far support portion 13a is arranged so as to avoid the imaging area of the camera 6.

The length of the support member 13 in the first direction X is set to such a length that the far support portion 13a fits within the to-be-sucked surface 101 of the article 100 sucked and held by the end effector 1. As a result, the far support portion 13a can be reliably brought into contact with the to-be-sucked surface 101, and the article 100 can be reliably held even when the article 100 is inclined.

Further, the article 100 are supported at a plurality of locations of the near support portion 12a and the far support portion 13a so that the article 100 can be held without dropping even when the article 100 shakes due to the inertial force generated when the article 100 is conveyed. As a result, the speed at which the article 100 is conveyed can be increased.

As described above, the support member 13, that is, the far support portion 13a is not provided in the second direction Y of the cover member 2. On the other hand, the two suction pads 3A and 3B are arranged along the second direction Y in the end effector 1 of the present example. As a result, the end effector 1 is supported by the first suction pad 3A and the second suction pad 3B in the second direction Y with respect to the to-be-sucked surface 101 of the article 100. As a result, the article 100 can be reliably held even when the second direction Y of the end effector 1 is inclined with respect to the horizontal direction.

### 2. Second Embodiment

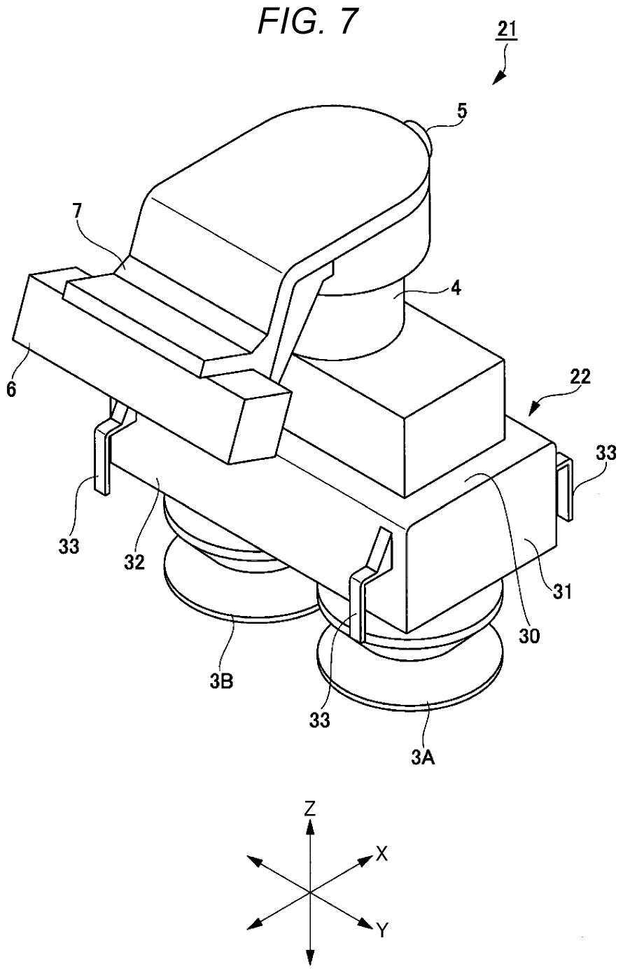

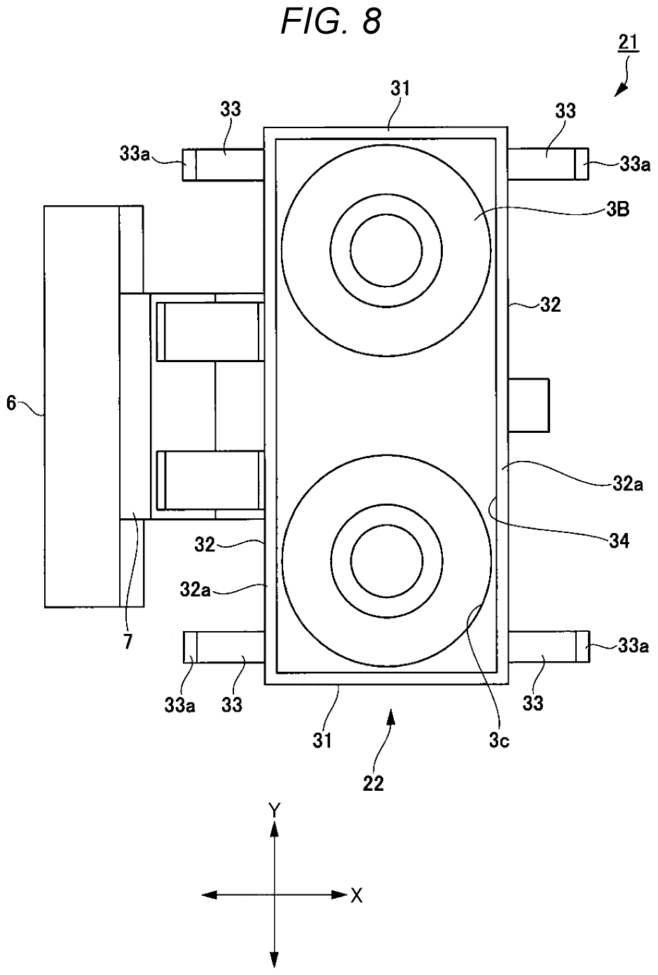

Next, an end effector according to a second embodiment will be described with reference to FIGS. 7 and 8.

FIG. 7 is a perspective view illustrating the end effector according to the second embodiment, and FIG. 8 is a plan view of the end effector according to the second embodiment as viewed from a bottom surface side.

A difference of an end effector 21 according to the second embodiment from the end effector 1 according to the first embodiment is a configuration of a cover member. Therefore, the cover member will be described here, and portions common to those of the end effector 1 according to the first embodiment will be denoted by the same reference signs, and the redundant descriptions thereof will be omitted.

As illustrated in FIGS. 7 and 8, the end effector 21 includes a cover member 22, the two suction pads 3A and 3B, the arm portion 4, the pipe joint 5, the camera 6, and the camera arm 7.

The cover member 22 is formed in a substantially rectangular parallelepiped shape that is hollow and has one open surface. The cover member 22 has an upper surface 30, a pair of first side surfaces 31 and 31, a pair of second side surfaces 32 and 32, and a plurality (four in the second embodiment) of support members 33.

The two suction pads 3A and 3B are arranged in a space 34 in the cover member 22. Outer edges of the suction surfaces 3c of the suction pads 3A and 3B are close to the near support portion 32a of the cover member 22.

The second side surface 32 is provided with the two support members 33 and 33. The two support members 33 and 33 are arranged with an interval in the second direction Y on the second side surface 32. The support member 33 protrudes from the second side surface 32 in the first direction X, and protrudes toward one end in the third direction Z. One end of the support member 33 in the third direction Z, that is, a distal end serves as the far support portion 33a.

The far support portion 33a is arranged with a predetermined interval in the first direction X with respect to the near support portion 32a. A height of the far support portion 33a in the third direction Z is set to the same height as the near support portion 32a.

The other configurations are the same as those of the end effector 1 according to the first embodiment, and therefore, the descriptions thereof will be omitted. The same operations and effects as those of the end effector 1 according to the above-described first embodiment can be obtained even with the end effector 21 according to the second embodiment.

Further, the distal end of the tongue-shaped support member 33 is configured as the far support portion 33a in the end effector 21 according to the second embodiment. As a result, it is possible to prevent the support member 33 and the far support portion 33a from interfering with an imaging area of the camera 6, and to increase the interval between the far support portion 33a and the near support portion 32a. As a result, the first rotational moment Ml acting around the far support portion 33a can be increased, and the article 100 can be stably sucked and held.

Although the example in which the four support members 33 and 33 are provided has been described in the end effector 21 according to the second embodiment, the number of the support members 33 is not limited to four, and five or more support members 33 may be provided on the cover member 22. Note that it is preferable to provide the plurality of support members 33 at symmetrical positions on the pair of second side surfaces 32 and 32 in order to hold the article 100 in a well-balanced manner.

### 3. Third Embodiment

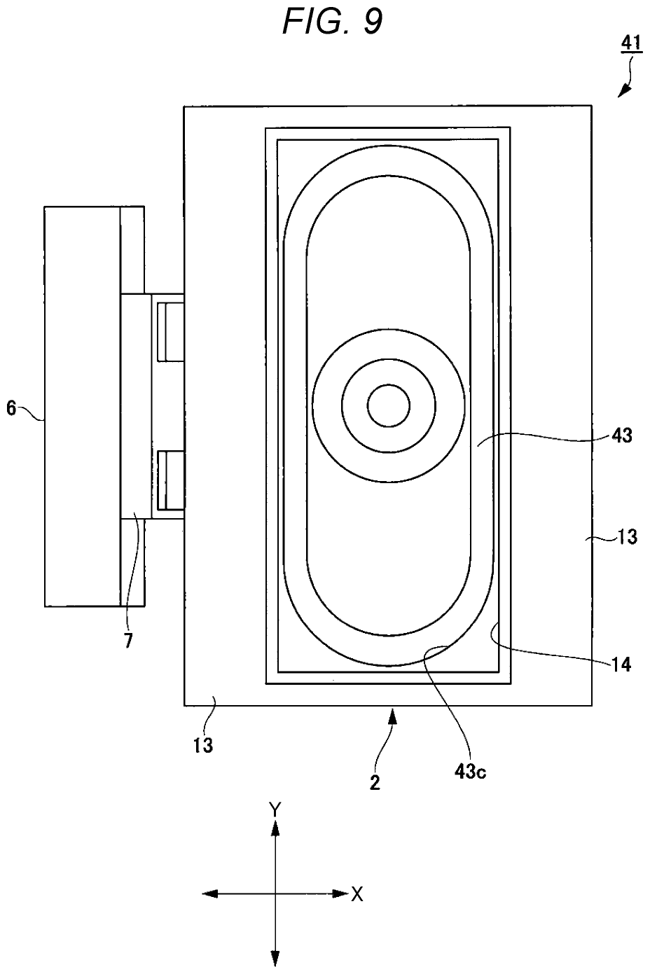

Next, an end effector according to a third embodiment will be described with reference to FIG. 9.

FIG. 9 is a plan view of the end effector according to the third embodiment as viewed from a bottom surface side.

A difference of an end effector 41 according to the third embodiment from the end effector 1 according to the first embodiment is a configuration of a suction pad. Therefore, the suction pad will be described here, and portions common to those of the end effector 1 according to the first embodiment will be denoted by the same reference signs, and the redundant descriptions thereof will be omitted.

As illustrated in FIG. 9, the end effector 41 has one suction pad 43. The suction pad 43 is arranged in the space 14 of the cover member 2. A suction surface 43c of the suction pad 43 is formed in an oval shape whose length in the second direction Y is longer than a length the first direction X so as to correspond to a rectangular opening of the cover member 2.

With the suction surface 43c of the suction pad 43 according to the third embodiment, a suction area can be made larger than that of the suction surfaces 3c of the suction pads 3A and 3B according to the first embodiment. As a result, with the end effector 41 according to the third embodiment, a suction force generated by the suction pad 43 can be made larger than that of the end effector 1 according to the first embodiment.

The other configurations are the same as those of the end effector 1 according to the first embodiment, and therefore, the descriptions thereof will be omitted. The same operations and effects as those of the end effector 1 according to the above-described first embodiment can be obtained even with the end effector 41 according to the third embodiment.

### 4. Fourth Embodiment

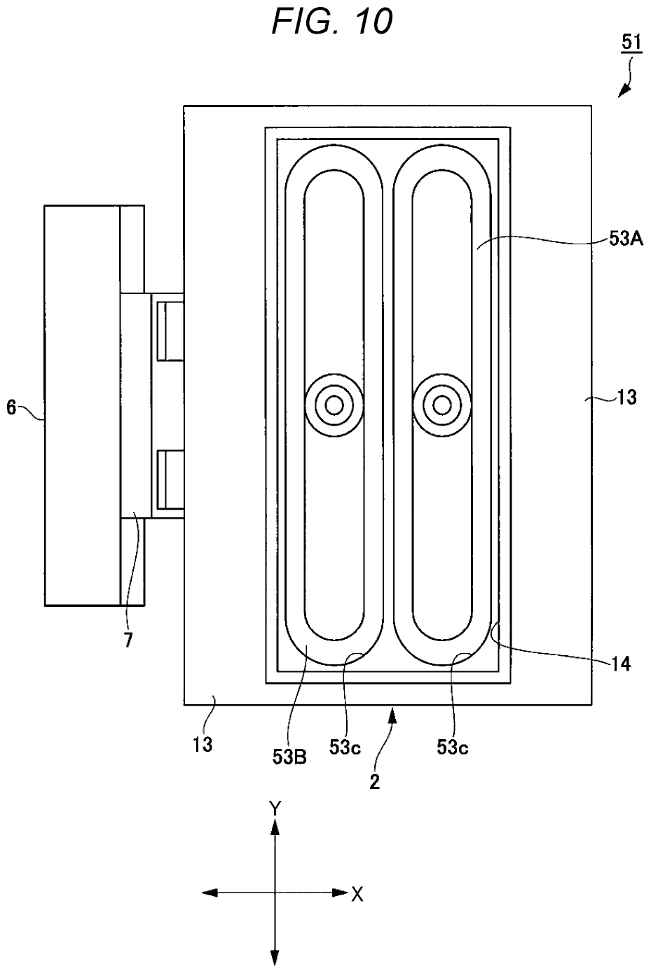

Next, an end effector according to a fourth embodiment will be described with reference to FIG. 10.

FIG. 10 is a plan view of the end effector according to the fourth embodiment as viewed from a bottom surface side.

A difference of an end effector 51 according to the fourth embodiment from the end effector 1 according to the first embodiment is a configuration of a suction pad. Therefore, the suction pad will be described here, and portions common to those of the end effector 1 according to the first embodiment will be denoted by the same reference signs, and the redundant descriptions thereof will be omitted.

As illustrated in FIG. 10, the end effector 51 has two suction pads 53A and 53B. The two suction pads 53A and 53B are arranged in the space 14 of the cover member 2. The first suction pad 53A is arranged on one side of the space 14 in the first direction X, and the second suction pad 53B is arranged on the other side of the space 14 in the first direction X.

Suction surfaces 53c of the suction pads 53A and 53B are formed in an oval shape whose length in the second direction Y is longer than a length in the first direction X. Further, the length of the suction surface 53c in the second direction Y is set to be substantially equal to a length of an opening of the cover member 2 in the second direction Y.

With the end effector 51 according to the fourth embodiment, articles whose heights in the third direction Z are different in the first direction X of the cover member 2 can also be sucked and held by the two suction pads 53A and 53B. With the end effector 51 according to the fourth embodiment, it is possible to suck and hold an article whose to-be-sucked surface is formed in a wave shape or an article whose to-be-sucked surface is soft.

The other configurations are the same as those of the end effector 1 according to the first embodiment, and therefore, the descriptions thereof will be omitted. The same operations and effects as those of the end effector 1 according to the above-described first embodiment can be obtained even with the end effector 51 according to the fourth embodiment.

Although the examples in which the cover members 2 and 22 are formed in the substantially rectangular parallelepiped shape that is hollow have been described in the end effectors 1, 21, 41, and 51 according to the above-described embodiments, the present invention is not limited thereto. The cover member may be formed in a substantially cubic shape having a square opening, a rectangular tube shape, a cylindrical shape, a dome shape, or other various shapes. Further, the locations where the support members are provided are not limited to both the ends of the cover member in the first direction X, and the support members may be provided continuously or at intervals at both ends in the second direction Y and the entire periphery of an outer peripheral surface of the cover member.

Although the examples in which the edges of the cover members 2 and 22 are applied as the near support portions have been described, the present invention is not limited thereto. A rod-shaped member arranged around the suction pad may be applied as the near support portion, or various other members may be applied as the near support portion.

### 5. Embodiment of Picking System

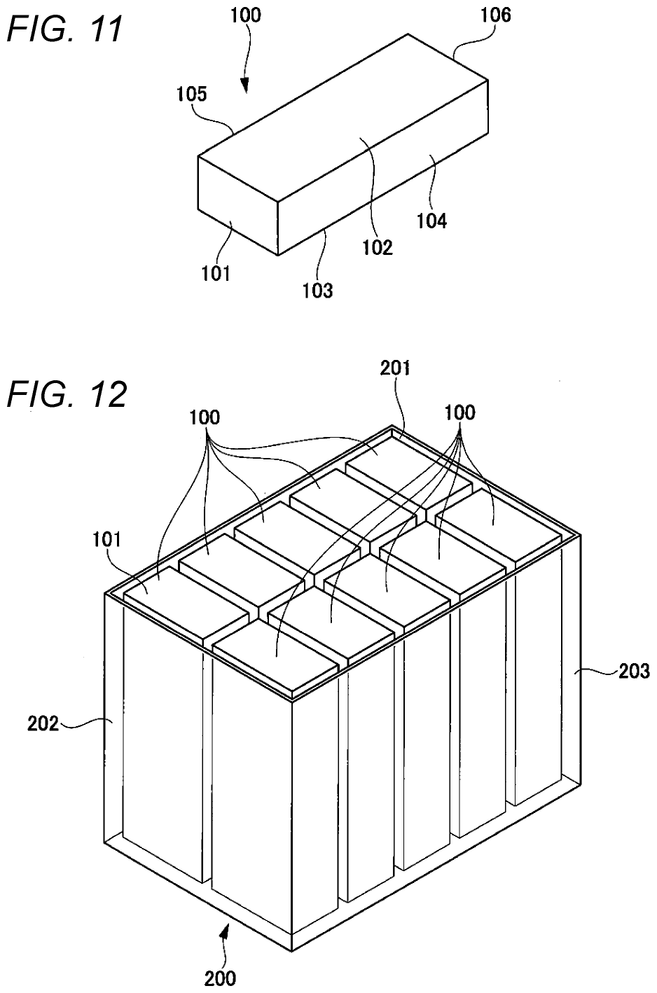

Next, an embodiment of a picking system including the end effector 1 configured as described above will be described with reference to FIGS. 11 to 28.

### 5-1. Examples of Article to Be Conveyed

First, examples of an article to be conveyed by the picking system will be described with reference to FIGS. 11 and 12.

FIG. 11 is a perspective view illustrating an example of the article.

As illustrated in FIG. 11, an article 100 is formed in a substantially rectangular parallelepiped shape that is long. The article 100 has a to-be-sucked surface 101, an upper surface 102, a bottom surface 103 opposing the upper surface 102, a back surface 106 opposing the to-be-sucked surface, and two side surfaces 104 and 105 opposing each other.

The upper surface 102 is formed in a substantially rectangular shape. The to-be-sucked surface 101 is arranged substantially vertically at one end of the upper surface 102 in the longitudinal direction, and the back surface 106 is arranged substantially vertically at the other end of the upper surface 102 in the longitudinal direction. The two side surfaces 104 and 105 are arranged substantially vertically at both ends of the upper surface 102 in the lateral direction.

The upper surface 102 is formed in a lid shape. That is, the upper surface 102 is formed so as to be separable from the to-be-sucked surface 101, the back surface 106, and the two side surfaces 104 and 105. Alternatively, the upper surface 102 is formed so as to be separable from the to-be-sucked surface 101 and the back surface 106, and is connected to one of the two side surfaces 104 and 105.

In the case of such an article 100, there is a possibility that accommodated contents may jump out of the article 100 if the upper surface 102 faces downward in the vertical direction. Therefore, the article 100 is normally placed with the bottom surface 103 or the back surface 106 facing downward in the vertical direction. Further, there is a possibility that the upper surface 102 may be open when the end effector 1 sucks the upper surface 102. Therefore, the end effector 1 sucks and holds the to-be-sucked surface 101 or the side surfaces 104 and 105 of the article 100.

FIG. 12 is a perspective view illustrating a state where the article 100 configured as above is stored in a storage cardboard.

As illustrated in FIG. 12, a storage cardboard 200 is formed in a substantially rectangular parallelepiped shape whose upper surface in the vertical direction is open. The storage cardboard 200 has side surfaces 202 and 203 and an opening 201 surrounded by the side surfaces 202 and 203. A plurality of the articles 100 are stored in the storage cardboard 200.

Further, the articles 100 are stored in a state where the to-be-sucked surface 101 faces upward in the vertical direction in order to improve storage efficiency and facilitate easy removal from the storage cardboard 200. Therefore, it is necessary to take out the article 100 from the storage cardboard 200 and convey the article 100 such that the lid-shaped upper surface 102 does not face downward in the vertical direction.

### 5-2. Configuration Example of Picking System

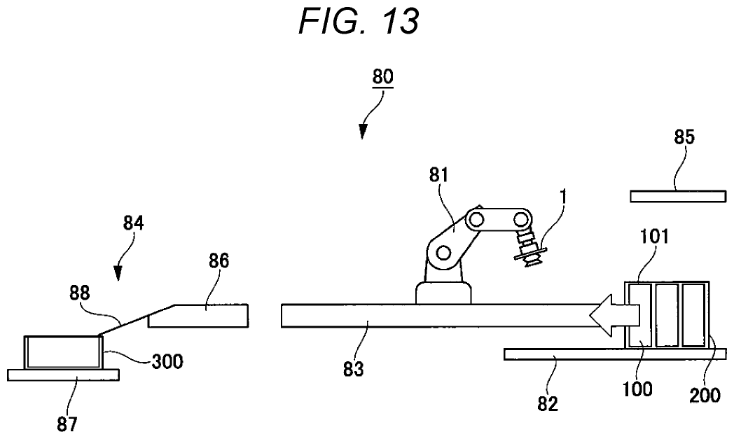

Next, a configuration example of the picking system that conveys the article 100 will be described with reference to FIG. 13.

FIG. 13 is a schematic configuration view illustrating the picking system.

As illustrated in FIG. 13, a picking system 80 includes: a transfer robot 81; a loading conveyor 82 that loads the article 100 into the transfer robot 81; a moving mechanism 83; an unloading unit 84 to which the article 100 is unloaded from the transfer robot 81; and a cardboard conveyor 85. The transfer robot 81 is, for example, a vertically articulated robot having six-axis joints. An arm of the transfer robot 81 is provided with the end effector 1 having the above-described configuration.

The transfer robot 81 is supported by the moving mechanism 83 so as to be movable in one axial direction. The loading conveyor 82 is arranged on one side in the moving direction of the moving mechanism 83. The loading conveyor 82 conveys the storage cardboard 200 storing the plurality of articles 100 from a process on the upstream side of the picking system 80 to a predetermined position. The cardboard conveyor 85 is arranged near the loading conveyor 82. The empty storage cardboard 200 is placed on the cardboard conveyor 85.

The unloading unit 84 is arranged on the other side in the moving direction of the moving mechanism 83. The unloading unit 84 includes a transfer device 86, an unloading container conveyor 87, and a slide plate 88. The transfer device 86 has a push plate (not illustrated) that pushes the placed article 100 to the slide plate 88.

An unloading container 300 that stores the conveyed articles 100 is placed on the unloading container conveyor 87. The unloading container conveyor 87 conveys the unloading container 300 storing the articles 100 to a process on the downstream side of the picking system 80. Further, the unloading container conveyor 87 conveys the empty unloading container 300 to a predetermined position in the unloading unit 84.

The slide plate 88 is arranged between the transfer device 86 and the unloading container conveyor 87.

The slide plate 88 has a sliding surface on which the article 100 conveyed from the transfer device 86 slides. Then, the slide plate 88 causes the article 100 to slide and be conveyed from the transfer device 86 to the unloading container 300 arranged on the unloading container conveyor 87.

The entire picking system 80 configured as above is controlled by a control device (not illustrated).

### 5-3. Operation Example of Picking System

Next, an operation example of the picking system 80 having the above-described configuration will be described with reference to FIGS. 13 to 28.

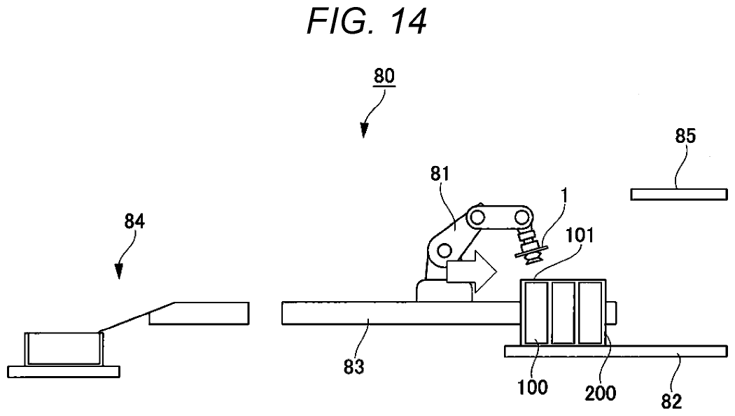

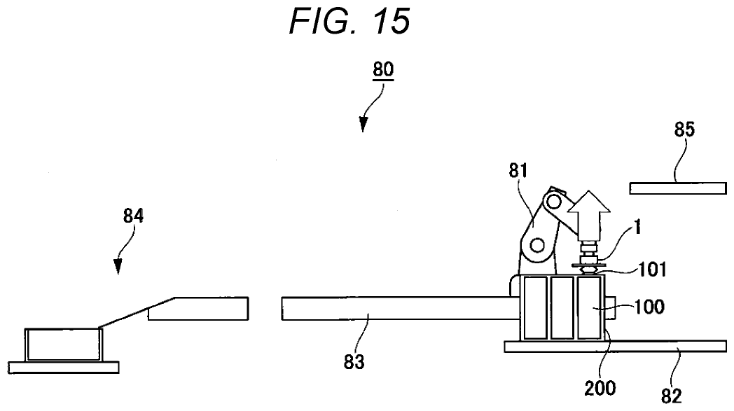

FIGS. 14 to 28 are explanatory views illustrating the operation example of the picking system 80.

First, the control device drives the loading conveyor 82 to convey the storage cardboard 200 storing the plurality of articles 100 from the upstream process to a predetermined position as illustrated in FIG. 13. Next, the control device drives the moving mechanism 83 to move the transfer robot 81 to a predetermined position, that is, a position where the article 100 is loaded as illustrated in FIG. 14.

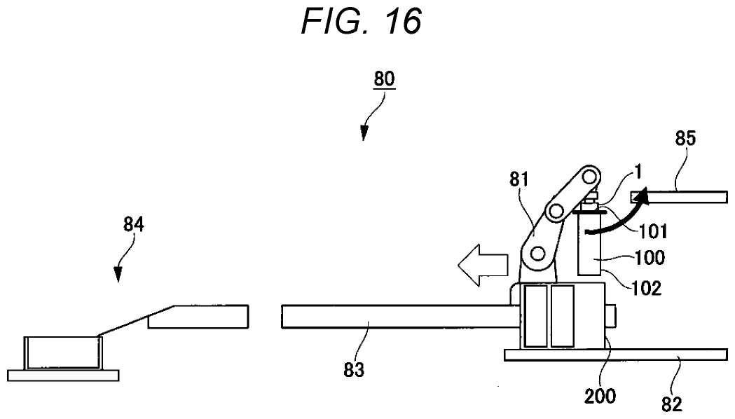

When the transfer robot 81 moves to the loading position, the transfer robot 81 rotates the arm such that the end effector 1 opposes the to-be-sucked surface 101 of the article 100 as illustrated in FIG. 15. Then, the article 100 is identified by the camera 6 (see FIG. 1) provided on the end effector 1, and a suction position on the end effector 1 is determined. The end effector 1 is moved to the suction position on the to-be-sucked surface 101 by rotating the arm of the transfer robot 81.

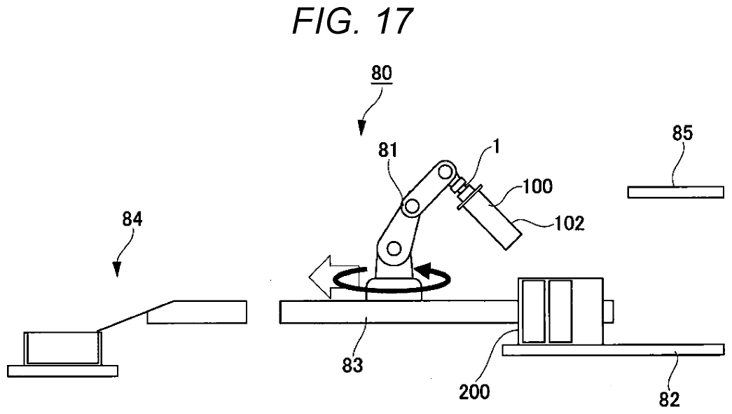

Next, the arm of the transfer robot 81 is rotated to bring the end effector 1 into contact with the to-be-sucked surface 101. Then, the control device drives the suction pump (not illustrated) to cause the suction pads 3A and 3B (see FIG. 1) of the end effector 1 to suck and hold the article 100. As illustrated in FIG. 16, the arm of the transfer robot 81 is rotated to pull out the article 100 from the storage cardboard 200.

The transfer robot 81 rotates the arm to incline the end effector 1 and the article 100 such that the upper surface 102 of the article 100 does not face downward in the vertical direction as illustrated in FIG. 17. Since the end effector 1 is provided with the near support portion 12a and the far support portion 13a that come into contact with and support the article 100 as described above, the article 100 can be surely sucked and held even if being inclined.

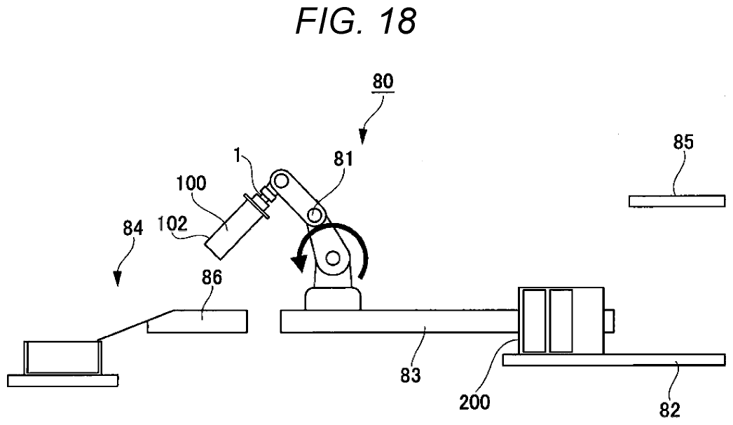

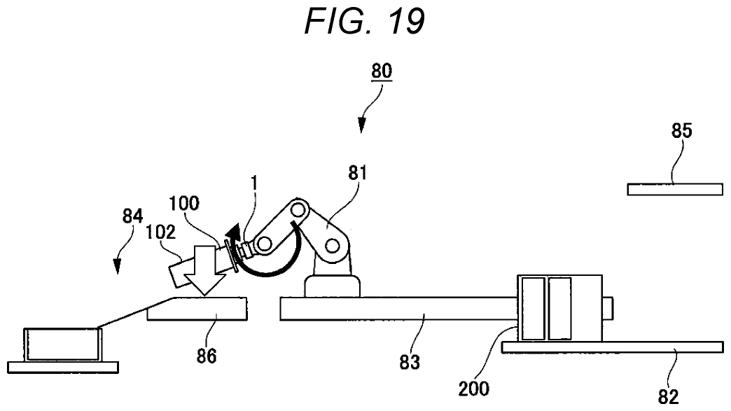

After the transfer robot 81 changes an attitude of holding the article 100 by rotating the arm, the control device drives the moving mechanism 83 to move the transfer robot 81 toward the unloading unit 84 as illustrated in FIG. 18. Note that the moving speed of the transfer robot 81 can be increased since the end effector 1 securely sucks and holds the article 100.

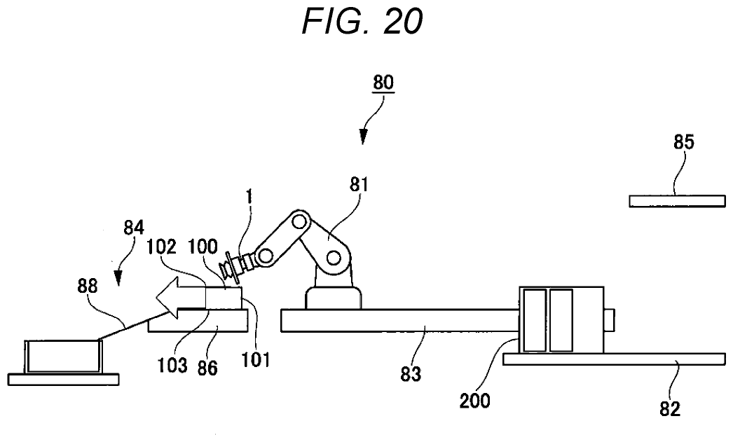

When the transfer robot 81 moves to a predetermined position, the transfer robot 81 rotates the arm such that the upper surface 102 of the article 100 faces upward in the vertical direction. Then, the transfer robot 81 places the article 100 on the transfer device 86 of the unloading unit 84 as illustrated in FIG. 19. At this time, when the upper surface 102 of the article 100 reaches a predetermined inclination, the control device stops driving the suction pump and separates the article 100 from the end effector 1. As a result, the article 100 is released from the end effector 1 and placed on the transfer device 86.

Note that it is preferable that the article 100 be separated from the end effector 1 in a state where the upper surface 102 of the article 100 is substantially parallel to the horizontal direction and the article 100 approaches the transfer device 86 in order to prevent the article 100 from being damaged when placed on the transfer device 86.

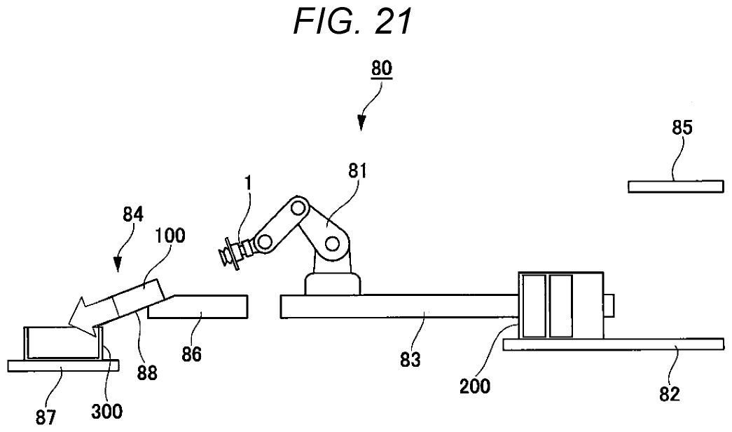

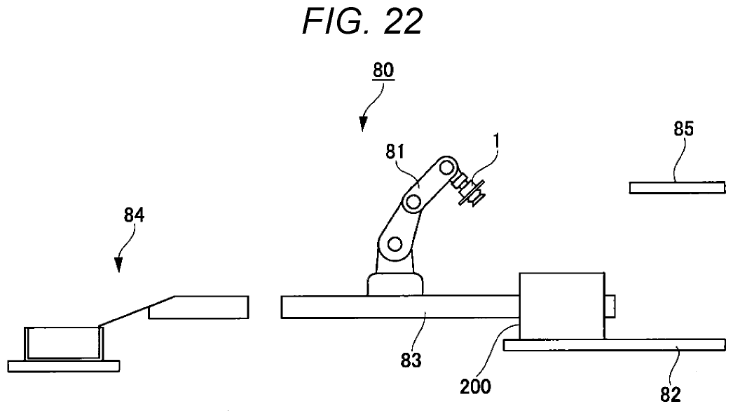

Next, the control device drives the transfer device 86 to convey the placed article 100 toward the slide plate 88 as illustrated in FIG. 20. When the center of gravity of the article 100 passes through a connecting point between the transfer device 86 and the slide plate 88, the article 100 slides on the slide plate 88 toward the unloading container conveyor 87 as illustrated in FIG. 21. Then, the article 100 is stored in the unloading container 300 arranged on the unloading container conveyor 87.

When the number of the articles 100 stored in the unloading container 300 reaches a predetermined number, the control device drives the unloading container conveyor 87 to convey the unloading container 300 storing the articles 100 to the downstream process of the picking system 80.

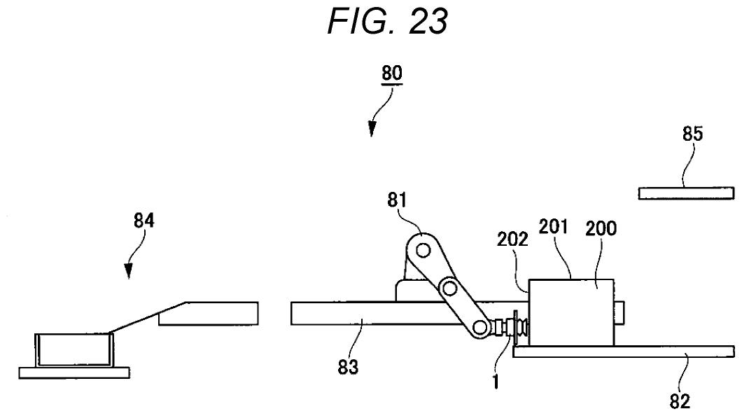

When the conveyance of the articles 100 to the unloading unit 84 is completed, the control device rotates the arm of the transfer robot 81 and drives the moving mechanism 83 to move the transfer robot 81 to a predetermined position again as illustrated in FIG. 22.

Next, a description will be given regarding an operation after the conveyance of the plurality of articles 100 stored in the storage cardboard 200 has been completed.

Note that an upper surface of the storage cardboard 200 in the vertical direction is open to take out the article 100. Therefore, the control device rotates the arm of the transfer robot 81 such that the end effector 1 opposes the side surface 202 of the storage cardboard 200 as illustrated in FIG. 23.

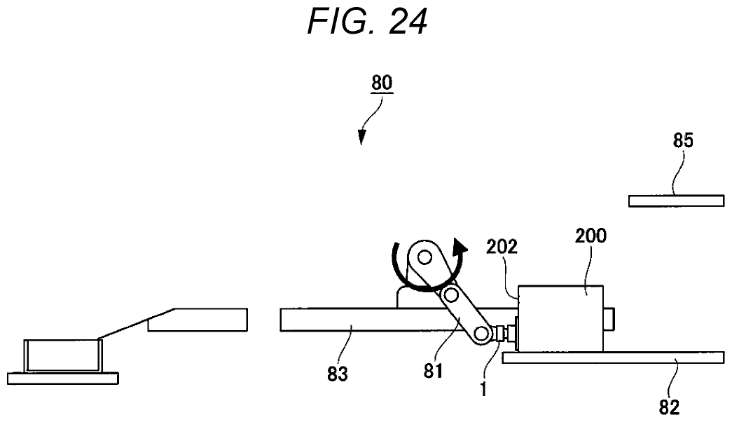

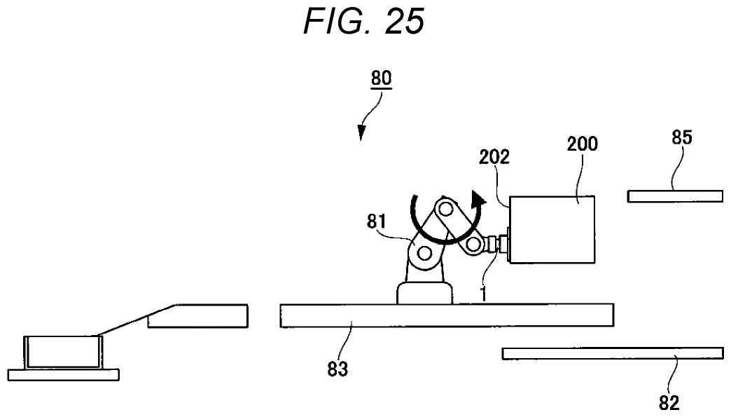

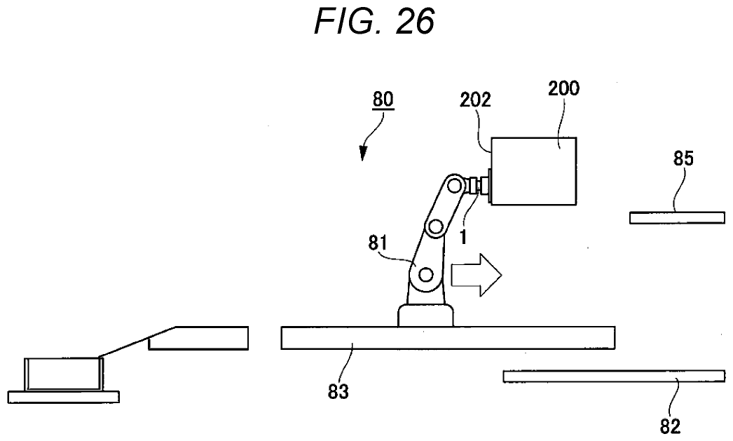

Then, the control device drives the suction pump (not illustrated) to suck and hold the side surface 202 of the storage cardboard 200 by the end effector 1 as illustrated in FIG. 24. Next, the control device rotates the arm of the transfer robot 81 to lift the storage cardboard 200 from the loading conveyor 82 as illustrated in FIG. 25.

When the storage cardboard 200 is lifted to a predetermined position as illustrated in FIG. 26, the control device drives the moving mechanism 83 to move the transfer robot 81 to the cardboard conveyor 85.

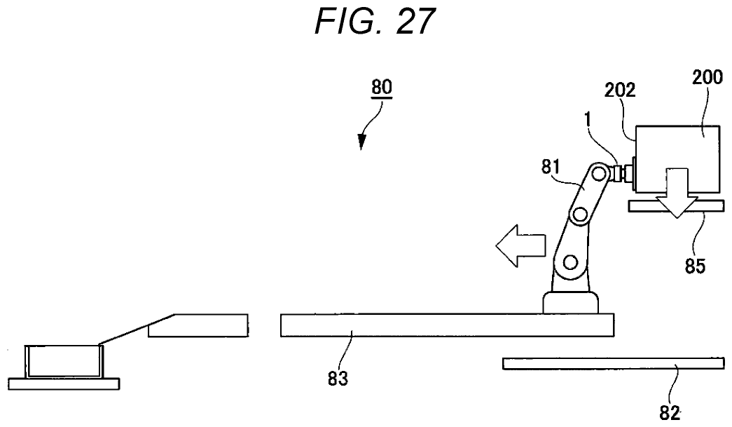

As illustrated in FIG. 27, when the transfer robot 81 moves to the cardboard conveyor 85, the arm of the transfer robot 81 is rotated to place the storage cardboard 200 on the cardboard conveyor 85. When the storage cardboard 200 approaches a predetermined position of the cardboard conveyor 85, the control device stops the suction pump to separate the storage cardboard 200 from the end effector 1. As a result, the storage cardboard 200 is placed on the cardboard conveyor 85.

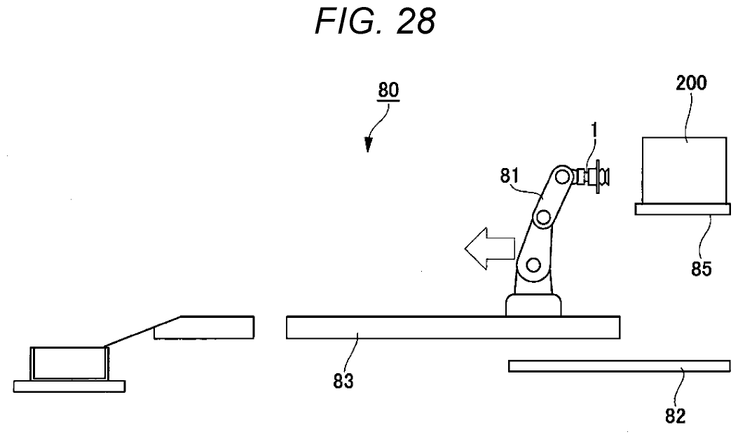

When the placing on the cardboard conveyor 85 in the storage cardboard 200 is completed as illustrated in FIG. 28, the control device drives the moving mechanism 83 to move the transfer robot 81 from the cardboard conveyor 85 to a predetermined position. Further, the control device drives the cardboard conveyor 85 to convey the placed storage cardboard 200 to a predetermined position. As a result, the operation of the picking system 80 is completed.

Note that the operation example of the picking system 80 is not limited to the above-described operation example, and various other operation examples are applied.

Although the example in which the vertically articulated robot having six-axis joints is applied as the transfer robot 81 has been described, the present invention is not limited thereto. As the transfer robot 81, a two-axis robot that performs rotation in the horizontal direction and movement in the vertical direction may be applied, and various other robots can be applied.

Although the example in which the transfer device 86, the unloading container conveyor 87, and the slide plate 88 are provided as the unloading unit 84 has been described, the present invention is not limited thereto, and the unloading unit 84 only has to have at least an unloading conveyor that unloads an article.

Further, the article conveyed by the picking system 80 is not limited to the article 100 illustrated in FIG. 11 or the storage cardboard 200 illustrated in FIG. 12, but various other articles are applied.

Incidentally, the invention is not limited to the embodiments described above and illustrated in the drawings, and various modifications can be made within a scope not departing from a gist of the invention described in the claims.

Incidentally, terms such as “parallel” and “orthogonal” are used in this specification, but the terms do not have strict meaning of “parallel” and “orthogonal” but may indicate states of “substantially parallel” or “substantially orthogonal” within a range in which a relevant function can be exerted including “parallel” and “orthogonal”.

What is claimed is:

1. An end effector comprising:
a suction pad having a suction surface that comes into contact with an article;
a near support portion that is arranged around an outer edge of the suction surface, comes into contact with the article, and supports the article; and
a far support portion that is arranged at a position farther from the outer edge of the suction surface than the near support portion, comes into contact with the article, and supports the article.

2. The end effector according to claim 1, further comprising
a cover member that surrounds a periphery of the suction pad and has an opening formed to expose the suction surface,
wherein the near support portion is an end on an opening side of the cover member.

3. The end effector according to claim 2, wherein
a support member is provided at the end on the opening side of the cover member, and
the far support portion is an end of the support member opposite to the cover member.

4. The end effector according to claim 2, wherein
a support member is provided on a side surface of the cover member that surrounds the periphery of the suction pad, and
the far support portion is an end of the support member opposite to the cover member.

5. The end effector according to claim 1, wherein
the near support and the far support are arranged on an identical plane,
the suction pad is configured to be extendable and contractible,
when the suction pad is extended, the suction surface is arranged at a position closer to the article than a plane formed by the near support portion and the far support portion, and
when the suction pad is maximally contracted, the suction surface is arranged at a position away from the article farther than the near support portion and the far support portion.

6. The end effector according to claim 1, further comprising
a camera that images the article,
wherein the far support portion is arranged so as to avoid an imaging area of the camera.

7. A picking system comprising:
an end effector that sucks, holds, and releases an article;
a transfer robot having the end effector provided on an arm;
a loading conveyor that loads the article to the transfer robot; and
an unloading unit to which the article is unloaded from the transfer robot,
wherein the end effector comprises:
a suction pad having a suction surface that comes into contact with and sucks the article;
a near support portion that is arranged around an outer edge of the suction surface and comes into contact with the article; and
a far support portion that is arranged at a position farther from the outer edge of the suction surface than the near support portion and comes into contact with the article.
